(19) United States
(12) Patent Application Publication
(10) Pub. No.: US 2008/0279130 A1
(43) Pub. Date: Nov. 13, 2008

(54) Bluetooth and Wireless Network Coexistence

(75) Inventor: Michael Lewis, London (GB)

Correspondence Address: LEE & HAYES, PLLC, 421 W RIVERSIDE, SUITE 500, SPOKANE, WA, 99201, US

(73) Assignee: INFINEON TECHNOLOGIES AG, Neubiberg (DE)

(21) Appl. No.: 11/747,692

(22) Filed: May 11, 2007

(51) Int. Cl. G08C 17/00; H04B 7/00

(52) U.S. Cl. 370/311; 455/41.3

(57) ABSTRACT

Implementations are presented herein that relate to Bluetooth® and Wireless Network Coexistence.

### BACKGROUND

Bluetooth® is a wireless standard that enables low power transceivers to communicate wirelessly over a short-range. In one example, a mobile telephone is implemented with a low power transceiver that is Bluetooth® compatible. A user may make use of the mobile telephone using a cordless headset that also incorporates a lower power transceiver that is Bluetooth® compatible. The use of a Bluetooth® enabled headsets in conjunction with mobile telephones eliminates cumbersome wires associated with wire-line implemented headsets, which may result in an improved user experience when operating mobile telephones.

The Wireless Local Area Networks (WLAN) standard 802.11x provides a wireless infrastructure that enables computing devices, such as portable computers and other mobile computing devices, to wirelessly communicate with a network. Generally a WLAN operates in an office environment or commercial establishment, such as a café, to enable mobile computing devices to communicate with a local area network or other network service provider.

Bluetooth® and WLAN both use the same radio frequency band of 2.4 to 2.5 GHz. Radio interference between devices using the two standards may degrade network communications. One such degradation is decreased data throughput and quality of voice service resulting in the two standards competing for the same bandwidth. This problem is amplified in systems that employ both Bluetooth® and WLAN standards.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 is a diagram that illustrates a system that includes a terminal in wireless communication with an access point. At least the terminal may be capable of communicating using a first wireless standard and a second wireless standard.

FIGS. 2-4 illustrate details of a data frame/packet that may be transmitted by a terminal to an access point.

FIG. 5 is a signal diagram that illustrates a plurality of communications between devices. The devices may include technology illustrated and described in connection with FIG. 1.

FIGS. 6-7 illustrate flow diagrams that include a number of operations enabling efficient coexistence of the Wireless Local Area Network (WLAN) standard, or another first wireless standard, and the Bluetooth® standard, or another second wireless standard.

### DETAILED DESCRIPTION

### Overview

In the following, a brief overview of the Bluetooth® and Wireless Local Area Networks (WLAN) 802.11x (e.g., 802.11a, 11b, 11g, or 11n) standards will be provided. Thereafter, implementations that enable coexistence of the two standards, which substantially eliminate network and data throughput degradation, will be described in detail. Although the description hereof refers to the coexistence of the wireless standards of Bluetooth® and WLAN, those skilled in the art understand that this is by way of example only. In particular, the implementations described herein may enable a plurality of wireless standards to coexist without substantially degrading data throughput of one or more of the plurality of wireless standards.

### Bluetooth®

The Bluetooth® standard describes how low power radio transceivers can be used to remotely communicate over a generally short range. These low power transceiver devices are already present in some computing devices, such as mobile phones, and can be used to receive input data from a peripheral computing device, such as data from a wireless headset. Communication between the headset and the mobile phone occurs between a low power radio transceiver in the headset and the low power radio transceiver in the phone.

Two or more units sharing the same Bluetooth® channel form a piconet. One Bluetooth® unit acts as the master of the piconet, whereas the other unit(s) acts as slave(s). Each piconet can only have a single master. A piconet is synchronized by the system clock of the master. The master does not adjust its system clock during the existence of the piconet. The slaves adapt their native clocks with a timing offset in order to match the master clock.

Bluetooth® occupies, when active, a section of the 2.4 GHz band that is 83 MHz wide. The standard uses a Frequency Hopping Spread Spectrum (FHSS) scheme that allows it to hop between 79 different 1 MHz wide channels in this band. The FHSS scheme is used by Bluetooth® to avoid radio channel interference.

### Wireless Local Area Networks

As indicated above, WLAN capable devices generally operate based on one or more of the 802.11x standards. WLAN provides a network connection, which works over a relatively large area without inconvenient cables. Typically a WLAN operates in an office or other commercial environment to enable computing devices to make a wireless connection to a local area network (LAN) of a company or other service provider. Wirelessly connecting to the LAN may be possible using a WLAN card interfaced with a computing device, or WLAN technology may be already integrated in the device.

A WLAN can either be formed of terminals, which use only wireless network connections, or it can exist as an extension of a wired network. A WLAN comprising only wireless terminals is usually called an ad hoc wireless local area network, as there are no other available communication methods in addition to the WLAN equipment to form the local area network. A network is called an infrastructure WLAN if other communication technology is available in addition to the wireless communication techniques.

Terminals connected to a WLAN can switch into a power savings mode. For instance in infrastructure WLAN a terminal may inform a base station (e.g., an access point) about this by using power management bits, also named power savings mode bits, in a Frame Control field associated with one or more data packets transmitted by the terminal. When a terminal is in PS mode the access point will not regularly transmit data to such a terminal, instead it buffers the data and transmits the buffered data only at a certain moment. Such a terminal, for which data has been buffered in the access point, is marked in a Traffic Indication Map (TIM) created and managed by the access point. By receiving and interpreting the TIM, a terminal may detect that there exists buffered data intended for it. Terminals operating in the power management mode (e.g., PS) will periodically listen to beacons including the TIM and transmitted by access points to determine if there is buffered data available for delivery.

When a terminal in PS mode detects that data for it is buffered in an access point, the terminal will transmit a short PS-Poll frame to the access point that indicates that the terminal is no longer in PS mode and may now receive data. The access point may respond by sending the buffered data, and/or the access point sends an acknowledgement that it received the PS-Poll and will transmit the data at a later point. A terminal may also terminate PS mode by successfully completing any frame exchange in which the power management bit in the packet transmitted by the terminal is cleared.

WLAN uses the same 2.4 GHz band occupied by Bluetooth®. However, WLAN uses Direct Sequence Spread Spectrum (DSSS) instead of FHSS. More specifically, the carrier of a WLAN system does not hop or change frequency in the manner that Bluetooth® does, instead the carrier remains centered on one frequency that is 22 MHz wide.

### Bluetooth & WLAN Coexistence

When a Bluetooth® device and a WLAN device are operating in the same area, the single 22 MHz wide channel occupies the same frequency space as 22 of the 79 Bluetooth® channels that are 1 MHz wide. Accordingly, when a Bluetooth® transmission uses a frequency that is simultaneously being used by a WLAN transmission, interference that degrades the transmission may occur.

When a Bluetooth® device encounters interference on a channel, it deals with the interference by hopping to a different channel and trying again. Furthermore, Bluetooth® has support for avoiding channels where interference has previously been detected (e.g. those used by a WLAN device). Therefore, Bluetooth® uses an efficient methodology to mitigate against channel interference. However, certain traffic types (e.g. voice links to a headset) do not support retransmission, and so interference can result in audible distortion of the audio signal.

When a WLAN device encounters interference, it assumes either that a collision has occurred due to two or more devices trying to transmit simultaneously or that the packet was lost due to random reception errors. In response to such an interference situation, the WLAN device implicitly issues an Automatic Repeat Request (ARQ) by not responding with an acknowledgement frame. This prompts the sending terminal (e.g. the WLAN access point) to resend the most recently sent data packet(s). In addition, in many 802.11x environments, access points often attempt to curtail channel interference by reducing data rate from a high Mbps rate to a low Mbps rate when a number of retransmissions have been required.

The different interference mitigating schemes associated with Bluetooth® and WLAN make coexistence of the two standards difficult. This coexistence problem is exasperated in computing devices that employ both Bluetooth® and WLAN technologies. Such multi-standard computing devices often wish to transmit and/or receive data packets of both standards simultaneously, or in a near-simultaneous manner; in some cases the device only has a single antenna that cannot be used simultaneously by both standards. To prevent mutual interference, permission to operate is arbitrated between the Bluetooth® and WLAN technologies depending on the relative priorities of the traffic to be received/transmitted by each. This can indicate that, for example, reception of a WLAN packet is interrupted by a high priority Bluetooth® transmit or receive operation. When an access point encounters a Bluetooth®/WLAN terminal transmitting Bluetooth®, such that reception of a packet from the access point or transmission of the corresponding acknowledgment is interrupted, the access point may perceive the missing acknowledge as being due to interference, which it attempts to mitigate by slowing its transmission rate. This may cause the data throughput to be reduced to an intolerable level. Moreover, the reduction of the transmission rate may increase the likelihood that a conflict will occur. This is true because Bluetooth® traffic typically has a fixed timing between high priority traffic instants.

### Exemplary Arrangements

The following described implementations provide Bluetooth® and WLAN coexistence arrangements and methodologies that substantially prevent a WLAN access point or peer in an ad-hoc network from degrading the data rate of its transmissions when a multi-standard (Bluetooth® and WLAN) terminal is transmitting or receiving Bluetooth data packets. More generally, the described implementations provide coexistence arrangements and methodologies that substantially prevent an access point, which uses a first wireless standard, from degrading the data rate of its transmissions when a multi-standard wireless terminal is transmitting or receiving data packets according to a second wireless standard such that operation of the first wireless standard is inhibited.

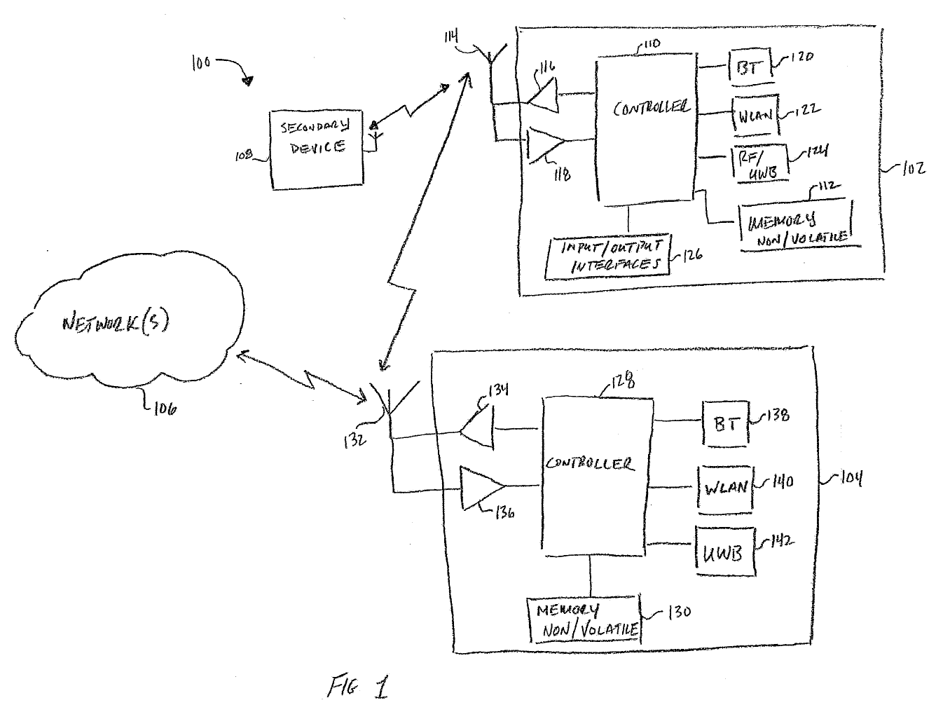

FIG. 1 is a diagram that illustrates a system 100 that includes a terminal 102 in wireless communication with an access point 104. In one implementation, the terminal 102 employs both WLAN and Bluetooth® functionality. More generally, the terminal 102 may employ technology that enables the terminal 102 to communicate using at least first and second wireless standards. The access point 104 may serve as a gateway to a network 106, such as a LAN, a personal area network, and/or a wide area network (WAN) such as the Internet. The access point 104 is shown as having a wireless connection to the network 106. However, the access point 104 may alternatively be connected to the network 106 by way of a wire-line interface (e.g., using Ethernet). The terminal 102 may be a mobile telephone, a portable computer, a personal digital assistant, a set-top box, or the like.

The terminal 102 communicates with the access point 104 using a first wireless standard (e.g., WLAN 802.11x) in order to gain access to the network 106. In general, the wireless interface between the terminal 102 and the access point 104 allows bidirectional transmission of data packets for dissemination and use by the two devices 102 and 104.

A secondary device 108 may be wirelessly connected to the terminal 102. The secondary device 108 may be a wireless headset, keyboard, mouse, or other similar device for use in connection with the terminal 102. The secondary device 108 communicates with the terminal 102 using a second wireless standard (e.g., Bluetooth®) in order enhance the functionality of the terminal 102. Generally, the wireless interface between the secondary device 108 and the terminal 102 allows bidirectional transmission of data packets for dissemination and use by the devices 108 and 102.

The terminal 102 includes technology for performing one or more of the described implementations. More specifically, the terminal 102 may include a controller 110, such as a processor, connected to a memory 112. The memory 112 may include volatile and/or non-volatile memory. The memory 112 generally stores data, such as data received from the secondary device 108 and the access point 104. In addition, the memory 112 may also store software applications that enable the terminal 102 to operate properly.

An antenna 114 is coupled to the terminal 102 to enable radio frequency (RF)-wireless-transmissions. The antenna 114 is coupled to a transmitter 116 and a receiver 118, or a transceiver. The terminal 102 also includes a Bluetooth® module 120, a WLAN module 122 and an RF/ultra wideband (UWB) module 124 to enable the terminal 102 to transmit and receive signals associated with the Bluetooth®, WLAN and UWB standards. The terminal may also have multiple antennas. However, the use of multiple antennas does not eliminate the need to employ Bluetooth® and WLAN coexistence systems and methods.

Input/output interfaces 126 may enable interactive use of the terminal 102. For example, the input/output interfaces 126 may include one or more displays, a keyboard or other input mechanism, and audio technology. The controller 110 interfaces and controls the operation of at least the foregoing technology of the terminal 102.

The access point 104 may be similarly designed as the terminal 102. The access point 104 includes technology for performing one or more of the described implementations. More specifically, the access point 104 may include a controller 128, such as a processor, connected to a memory 130. The memory 130 may include volatile and/or non-volatile memory. The memory 130 generally stores data, such as data received from the terminal 102, or data received from another wireless device. In addition, the memory 130 may also store software applications that enable the access point 104 to operate properly.

An antenna 132 is coupled to the access point 104 to enable RF-wireless-communications. The antenna 132 is coupled to a transmitter 134 and a receiver 136, or a transceiver. The access point 104 also includes a Bluetooth® module 138, a WLAN module 140 and an RF/UWB module 142 to enable the access point 104 to transmit and receive signals associated with the Bluetooth®, WLAN and UWB standards. The controller 128 interfaces and controls the operation of at least the foregoing technology of the access point 104. Although not shown in FIG. 1, similar to the terminal 102, the access point 104 may also include input/output interfaces.

Coexistance of WLAN (e.g., a first wireless standard) and Bluetooth® (e.g., a second wireless standard) will now be discussed. As was discussed earlier herein, WLAN may employ a scheme that may attempt to curtail channel interference by reducing data rate from a high Mbps rate to a low Mbps rate. This channel interference may occur when the terminal 102 is busy communicating with a Bluetooth® enabled device, such as the secondary device 108, and the access point 104 is attempting to send WLAN data packets to the terminal 102 while the Bluetooth® session is ongoing.

According to one implementation, the terminal 102 substantially prevents Bluetooth® and WLAN interference by preemptively notifying the access point 104 before a Bluetooth® session begins. In one example, the terminal 102 sends a data packet to the access point 104 that instructs the access point 104 to begin buffering data for communication to the terminal 102. The memory 130 may be used to buffer such data. Once the terminal 102 finishes the Bluetooth® session, the terminal 102 sends a data packet that indicates that the terminal 102 is ready to receive WLAN data. The access point 104 may respond to this data packet by sending the terminal 102 data that was buffered on its behalf, and also commence normal WLAN communications with the terminal 102.

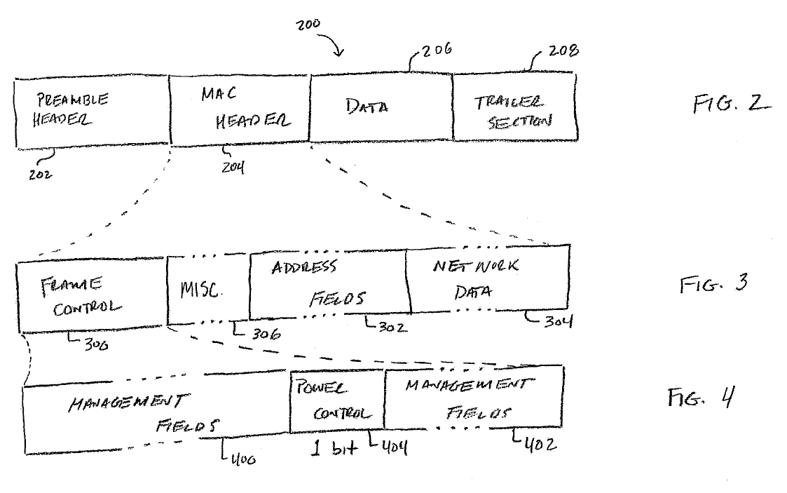

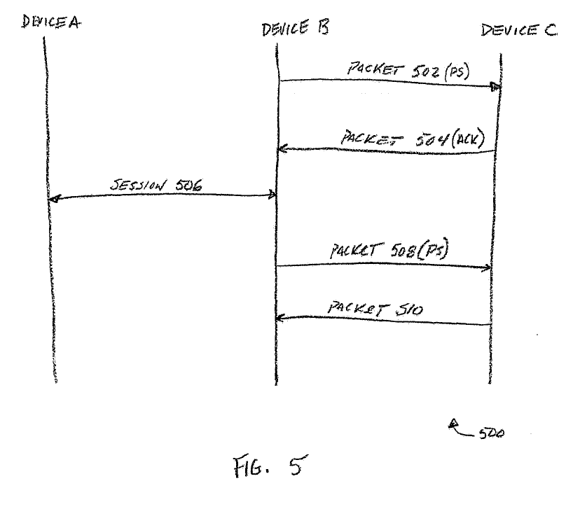

FIG. 2 illustrates a data frame/packet 200 that may be transmitted by the terminal 102 to the access point 104. The data packet 200 may include a preamble header 202. The preamble header 202 may be used by network hardware to control a transmission, contain information related to the structure of the remaining portion of the packet 200, and to maintain a physical link between stations (e.g., a link between the terminal 102 and the access point 104). A management (MAC) header 204 may follow the preamble header 202. The MAC header 204 may include management information that pertains to wireless existence and coexistence mechanisms, in addition to a number of other network management functions. A portion of the MAC header 204 will be discussed in greater detail in connection with FIG. 3. A data frame 206 and a trailer section 208 may also be included in the packet 202. The data frame 206 may include data for dissemination and use by a receiving entity, and the trailer section 208 may include Cyclic-Redundancy Check (CRC) bits.

FIG. 3 illustrates a number of sub-frames that may be associated with the MAC header 204. Generally, sub-frames associated with the MAC header 204 are dictated by the type of packet, data, network management requirements, and/or control requirements. The MAC header 204 is show as including a frame control frame 300, which is discussed in greater detail in connection with FIG. 4. The MAC header 204 may also include a number of address fields 302 and network data 304.

FIG. 4 illustrates that the frame control frame 300 may include two management fields 400 and 402. Although not show in FIG. 4, the management fields 400 and 402 may comprise a number of bit or multi-bit sized frames. One such frame is a power control frame 404. Conventionally, the power control frame 404 may be used by a device (e.g., the terminal 102) to notify another device (e.g., the access point 104) that the terminal 102 is about to enter a power savings mode. After receiving a frame in which the power control field is set, the access point 104 buffers data for communication to the terminal 102 until a frame is received and that indicates that the power savings mode is no longer active; e.g. a frame with the power control field cleared, or a special PS-Poll (power save-poll) frame.

One or more implementations described herein make use of the power control frame 404 to prevent WLAN transmissions (e.g., first wireless standard communications) from the access point 104 when the terminal 102 is about a begin a Bluetooth® session (e.g., second wireless standard communications) where the terminal 102 is sending or receiving Bluetooth® signals.

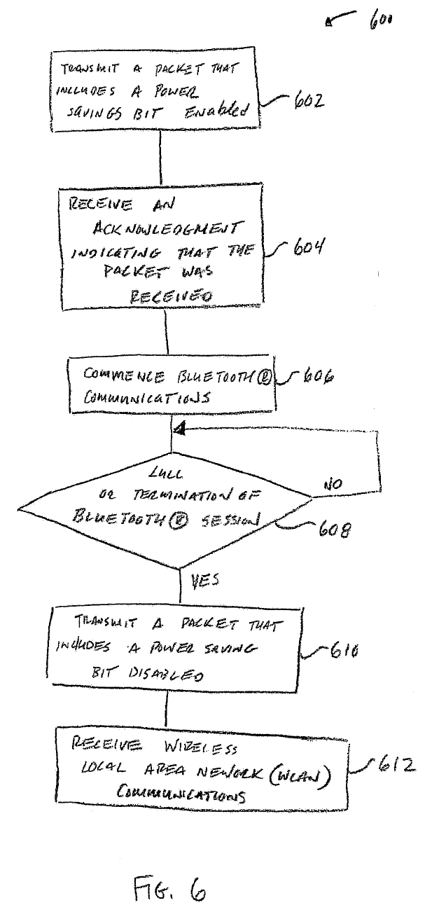

FIG. 5 is a signal diagram 500 that illustrates a plurality of communications between devices A, B, and C. The devices A, B, and C may include technology illustrated and described in connection with FIG. 1. However, the devices A, B, and C are not limited to the technology illustrated in FIG. 1.

In one implementation, the device B (e.g., the terminal 102) may send the device C (e.g., the access point 104) a packet 502 that includes an indication that the device B is about to enter a power savings mode. The packet 502 may include an instruction, a toggled bit, such as a power management bit, or the like, that indicates that the device B is about to enter the power savings mode (PS). The packet 502 may contain other data for the device C, or the packet 502 may be a “null” packet having the sole purpose to communicate that the device B is about to enter the power savings mode.

In response to the packet 502, the device C sends the device B a packet 504. The packet 504 includes an acknowledgement (ACK) that the packet 502 was received. The device C will now buffer data for delivery to the device B, and suspends WLAN communications (e.g., first wireless standard communications) with the device B.

Having received the packet 504, the device B may now start a Bluetooth® session 506 (e.g., second wireless standard communications) with the device A. The device C believes the device B is in power savings mode, but in reality the device B has used power savings reporting functionality to ensure that the device C does not attempt to communicate while the session 506 is ongoing. Optionally, the device B may start the Bluetooth® session even if the packet 504 has not been received. In this case, the device B would not know with certainty that device C believes that it is in power savings mode. The device B may need to start a Bluetooth® session before receiving an acknowledgment when the transfer of real-time data (e.g., audio data) is necessary.

After the session 506 is over, or while there is a lull in the session 506, the device B may send the device C a packet 508 that includes an indication that the device B is no longer in the power savings mode. The packet 508 may include an instruction, a toggled bit, such as a power management bit, or the like, that indicates that the device B is not in the power savings mode (PS). After receiving the packet 508, if data was buffered for the device B, the device C may transmit such buffered data to the device B (packet 510).

Processors, memory, transmitters, receivers and other functional elements of the devices A, B and C provide the functionality enabling the communications illustrated in FIG. 5. In general, computer readable instructions in the devices A, B and C, which may be stored in respective memories and storage of the devices, may aid in the formation, transmission, and reception of the discussed packets. Processors of the devices may execute such computer readable instructions in accordance with device and/or user demands.

The technology shown in FIGS. 1-5 is merely illustrative of select components that may be used to design the illustrated implementations. Those of ordinary skill in the art appreciate many other component combinations may be used to develop the devices illustrated in the figures.

### Procedure

The following discussion describes procedures that may be realized utilizing the previously described implementations. In one implementation, the illustrated and described procedures may be used to allow WLAN and Bluetooth® to coexist.

The procedures are illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. In portions of the following discussion, reference may be made to the illustrations of FIGS. 1-5 and the subject matter thereof.

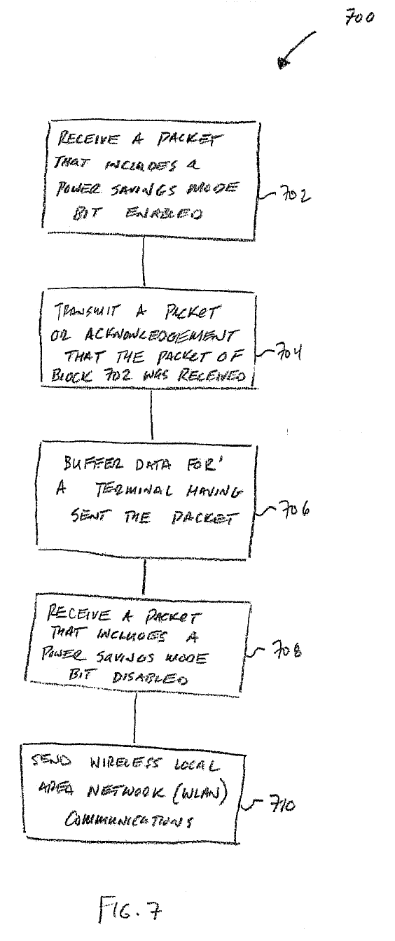

FIGS. 6-7 illustrate a flow diagrams 600 and 700 that include a number of operations enabling efficient coexistence of the WLAN standard, or another first wireless standard, and the Bluetooth® standard, or another second wireless standard.

At block 602, a terminal, such as the terminal 102 illustrated in FIG. 1, transmits a packet that includes an enabled power savings mode bit (e.g., a high logic level). Normally, the terminal would enable the power savings mode bit when it is about to enter a power savings mode. However, in this case, the terminal enables the power savings mode bit because it is about to begin a Bluetooth® session. The packet including the enabled power savings mode bit may be a packet carrying data, or a “null” packet carrying only the enabled power savings mode bit. An access point, such as the access point 104 of FIG. 1, or a peer in an ad-hoc network, normally buffers data for terminals that indicate that they are in a power savings mode.

At block 604, the terminal receives an acknowledgement that the packet containing the enabled power savings mode bit has been received. The acknowledgement may be sent by an access point that received the packet containing an enabled power savings mode bit. At block 606, the terminal commences a Bluetooth® communications session. Block 606 may be commenced even if the acknowledgment in block 604 is not received, in the event that the start of the Bluetooth® communications session cannot be deferred. At block 608, it is determined if there is a lull in the Bluetooth communications session, or if the Bluetooth® communications session has terminated.

At block 610, if there is a lull or if the Bluetooth® communications session has terminated, then the terminal transmits a packet that has a power savings mode bit disabled (e.g., a low logic level). The packet including the disabled power savings mode bit may be a packet carrying data, or a “null” packet carrying only the disabled power savings mode bit. An access point, such as the access point 104 of FIG. 1, or a peer in an ad-hoc network, may send buffered data to the terminal that sent the packet. At block 612, the terminal that sent the packet including the disabled power savings mode bit begins to receive WLAN communications from an access point or peer in an ad-hoc network.

Referring to FIG. 7, at block 702, an access point or peer in an ad-hoc network receives a packet that includes a power savings mode bit enabled (e.g., a logic level high), the packet transmitted by a terminal before beginning a Bluetooth® communications session. At block 704, the access point or peer in an ad-hoc network sends the terminal an acknowledgement that the packet from block 702 was received. At block 706, the access point or peer in an ad-hoc network begins buffering data for the terminal that transmitted the packet. At block 708, the access point or peer in an ad-hoc network receives a packet that includes a power savings mode bit disabled (e.g., a logic level low). Although not shown in the figure, the access point or peer in the ad-hoc network may send the terminal an acknowledgement that the packet from block 708 was received. At block 710, the access point or peer in an ad-hoc network sends buffered data and other WLAN data communications to the terminal that sent the packet of block 708.

The foregoing procedures enable a multi-standard terminal to conduct Bluetooth® communications without jeopardizing a speed at which one or more access points transmit WLAN communications. In one implementation, this is accomplished by reporting that a terminal is entering a power savings mode, when in reality the terminal is preparing to commence a Bluetooth communications session.

### CONCLUSION

For the purposes of this disclosure and the claims that follow, the terms “coupled” and “connected” have been used to describe how various elements interface. Such described interfacing of various elements may be either direct or indirect. Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A method, comprising:
transmitting an instruction that a wireless communications capable apparatus is intending to enter a power savings mode, the instruction transmitted using a first wireless standard and prior to the wireless communications capable apparatus commencing a wireless communications session using a second wireless standard.

2. The method according to claim 1, wherein the transmitting of the instruction occurs although the wireless communications capable apparatus is not about to enter a power savings mode.

3. The method according to claim 1, wherein the first wireless standard is one of the Wireless Local Area Network (WLAN) standards 802.11x.

4. The method according to claim 1, wherein the second wireless standard is Bluetooth®.

5. The method according to claim 1, wherein the transmitting includes transmitting a packet that includes a power savings mode bit enabled, the enabled power savings mode bit to instruct an apparatus receiving the packet to buffer data to distribute to an apparatus transmitting the packet.

6. The method according to claim 1, further comprising commencing a wireless communications session using the second wireless standard after the instruction has been transmitted.

7. The method according to claim 1, further comprising receiving an acknowledgement that the instruction was received, and commencing a wireless communications session using the second wireless standard after the acknowledgement is received.

8. A Wireless Local Area Network (WLAN) 802.11x and Bluetooth® coexistence method, comprising:
enabling a power management bit to a position indicating a power savings mode; and
transmitting a communication including the power management bit enabled to the position indicating the power savings mode before commencing a Bluetooth® session.

9. The method according to claim 8, wherein the transmitting transmits a packet including the power management bit enabled to the position indicating the power savings mode.

10. The method according to claim 8, further comprising receiving an acknowledgement that the communication including the enabled power management bit was received.

11. The method according to claim 8, further comprising commencing a Bluetooth® session immediately after transmitting the communication including the enabled power management bit.

12. The method according to claim 8, further comprising receiving an acknowledgement that the communication including the enabled power management bit was received, and commencing a Bluetooth® session after receiving the acknowledgment.

13. An apparatus having at least wireless capabilities, comprising:
at least one module to enable data transmissions using first and second wireless standard techniques; and
a processor associated with the at least one module, the processor to prepare a first instruction indicating an apparatus is in a power savings mode, the processor to issue the first instruction using a carrier signal based on the first wireless standard, the processor to issue the first instruction before the processor issues a second instruction to commence communications using the second wireless standard.

14. The apparatus according to claim 13, wherein the first wireless standard is one of the Wireless Local Area Network (WLAN) standards 802.11x.

15. The apparatus according to claim 13, wherein the second wireless standard is Bluetooth®.

16. The apparatus according to claim 13, wherein the first instruction is a packet that includes a power savings mode bit enabled, the enabled power savings mode bit to instruct an apparatus to buffer data to distribute to an apparatus transmitting the packet.

17. The apparatus according to claim 13, further comprising a transmitter coupled to the processor, the transmitter to transmit the first instruction indicating an apparatus is in a power savings mode.

18. The apparatus according to claim 17, further comprising a receiver coupled to the processor, the receiver to receive an acknowledgement that the first instruction has been received.

19. The apparatus according to claim 13, wherein the processor issues the second instruction immediately after the issuance of the first instruction, the issuance of the second instruction allowing an apparatus to commence communications using the second wireless standard.

20. The apparatus according to claim 13, wherein the processor issues the second instruction after the issuance of the first instruction and after an acknowledgement is received that indicates that the first instruction was received.

21. The apparatus according to claim 13, wherein the first instruction is a packet that includes a power savings mode bit enabled, the enabled power savings mode bit to instruct an apparatus receiving the packet to buffer data to distribute to an apparatus transmitting the packet.
